(19) United States
(12) Patent Application Publication
(10) Pub. No.: US 2026/0133073 A1
(43) Pub. Date: May 14, 2026

(54) TEMPERATURE SENSING FOR DISSOLUTION TESTING AND THE LIKE

(71) Applicant: Distek, Inc., North Brunswick, NJ (US)

(72) Inventors: Wenyu Wang, Pennington, NJ (US); Ryan Vrabel, Cream Ridge, NJ (US); Jeff Watkins, Princeton, NJ (US); Jeff Brinker, Westfield, NJ (US); Joey Yangco, Hampton, NJ (US)

(73) Assignee: Distek, Inc., North Brunswick, NJ (US)

(21) Appl. No.: 18/947,238

(22) Filed: Nov. 14, 2024

(51) Int. Cl. G01K 1/024; G01K 1/14; G01K 7/20; G01K 13/02; G01N 1/28; G01N 1/38

(52) U.S. Cl. CPC G01K 1/024; G01K 1/14; G01K 7/20; G01K 13/026; G01N 1/286; G01N 1/38

(57) ABSTRACT

A (e.g., dissolution) testing system has one or more stationary reader units and one or more corresponding rotatable shaft assemblies. Each reader unit has reader circuitry electrically connected to a reader antenna. Each shaft assembly has shaft circuitry electrically connected to a temperature sensor and a shaft antenna. The reader circuitry controls the reader antenna to wirelessly convey electrical energy to the shaft circuitry via the shaft antenna. The shaft circuitry controls the shaft antenna based on temperature measurements from the temperature sensor to wirelessly convey corresponding temperature information to the reader circuitry via the reader antenna. The testing system may employ a Near-Field Communication protocol to convey both the electrical energy and the temperature information.

### BACKGROUND

### Field of the Disclosure

The present disclosure relates to temperature sensing and, more specifically but not exclusively, to rotatable, temperature-sensing, shaft assemblies for dissolution testing and the like.

### Description of the Related Art

This section introduces aspects that may help facilitate a better understanding of the disclosure. Accordingly, the statements of this section are to be read in this light and are not to be understood as admissions about what is prior art or what is not prior art.

Measuring temperature accurately during the dissolution process has long posed a challenge, as traditional methods often disrupt the flow dynamics within the dissolution vessel. Typically, temperature measurement has been conducted manually by inserting a calibrated temperature sensor for a single, momentary reading. Adjustments are then made to the surrounding bath temperature in an effort to approximate the desired conditions. However, this method is flawed as it fails to provide continuous temperature monitoring throughout the dissolution run, potentially leading to inconsistent and unreliable test results.

U.S. Pat. No. 10,164,716, the teachings of which are incorporated herein by reference, describes a design that integrated a temperature sensor into the bottom of a hollow shaft connected to the test apparatus and used infrared (IR) technology to wirelessly transmit the temperature signal from the rotating shaft to a receiver board. While this design marked significant progress, it also introduced a number of challenges including:
The need to stock multiple shaft configurations to accommodate different vessel sizes or apparatus requirements;
High manufacturing costs associated with ensuring the straightness of long shafts and the complex process of potting the sensor in place;
Susceptibility of the temperature sensor to ambient lab conditions due to a large section of the shaft being exposed above the liquid;
The need for extremely thin-walled shafts to minimize thermal momentum effects, which compromised the shaft's structural integrity;
Temperature drift when the shaft was lifted out of the heated media for sampling or tablet addition, resulting in unstable readings;
The need for a rotating power source limited the design to using batteries mounted on the shaft. Lithium-ion batteries, although optimal, presented transportation challenges, while alkaline batteries were unsuitable for laboratory use due to their unstable voltage and limited life;
IR transmission required precise alignment between the rotating shaft and the receiver board to satisfy line-of-sight requirements, leading to potential delays and unstable temperature control when monitoring multiple shafts simultaneously; and
Advances in LED technology led to the proliferation of IR wavelengths in laboratories, causing signal interference and loss of temperature readings.

### SUMMARY

Problems in the prior art are addressed in accordance with the principles of the present disclosure by a rotatable, temperature-sensing, shaft assembly for dissolution testing and the like. In at least one embodiment of the present disclosure, a dissolution testing system has one or more stationary reader units and one or more corresponding rotatable shaft assemblies. Each reader unit has reader circuitry electrically connected to a reader antenna. Each shaft assembly has shaft circuitry electrically connected to a temperature sensor and a shaft antenna. The reader circuitry controls the reader antenna to wirelessly convey electrical energy and data to the shaft circuitry via the shaft antenna. The shaft circuitry controls the shaft antenna based on temperature measurements from the temperature sensor to wirelessly convey corresponding temperature information to the reader circuitry via the reader antenna. The dissolution testing system may employ a Near-Field Communication (NFC) protocol to convey both the electrical energy and the temperature information.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified, front view of a dissolution testing system of the present disclosure;

FIG. 2 is a more-detailed, perspective view of a portion of one possible implementation of the dissolution testing system of FIG. 1;

FIG. 3 is a perspective view of the top portion of one of the shaft assemblies of FIG. 2;

FIG. 4 is a perspective view of a portion of another possible implementation of the dissolution testing system of FIG. 1;

FIG. 5 is an exploded, perspective view of one of the shaft assemblies of FIG. 1;

FIG. 6 is a cross-sectional, side view of the shaft assembly of FIG. 5;

FIG. 7 is a perspective view of the temperature-sensor adapter and the temperature-sensor cable of FIGS. 5 and 6 with the temperature sensor potted within the adapter;

FIG. 8 is a cross-sectional, exploded, perspective view of the adapter, the temperature sensor connected at the end of the cable, the proximal O-ring, and the shaft of FIGS. 5 and 6;

FIG. 9 is a cross-sectional, perspective view of the adapter, the shaft, the proximal O-ring, the temperature sensor, and the cable of FIGS. 5 and 6;

FIG. 10 is a zoomed-in, cross-sectional, side view of the shaft, the adapter, the O-rings, the temperature sensor, and the cable of FIGS. 5 and 6 and a paddle attachment;

FIG. 11 is a schematic block diagram of the electronics associated with a single shaft assembly of FIG. 1; and

FIG. 12 is a circuit diagram of one possible implementation of the regulator, the signal-conditioning amplifier, the A/D converter, and the temperature-measurement circuit of FIG. 11.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

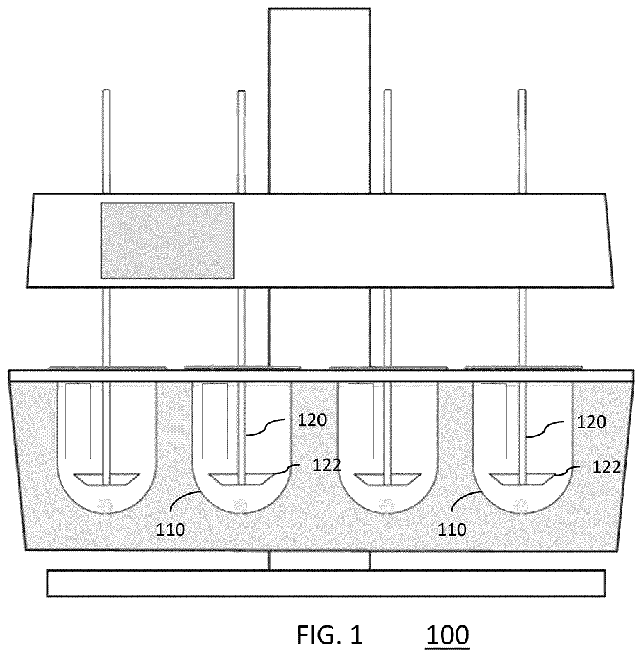

FIG. 1 is a simplified, front view of a dissolution testing system 100 having eight test vessels 110 (four of which are visible in FIG. 1), each vessel having a temperature-sensing shaft assembly 120 with, in this instance, a paddle 122 configured at the end of the shaft. Those skilled in the art will understand that, instead of a paddle 122, each assembly 120 may be independently configured with a different attachment, such as (without limitation) a pill basket or rotating cylinder. As described further below, configured within each temperature-sensing shaft assembly 120 is a temperature sensor that, during dissolution testing, continuously measures the temperature of the solution within the test vessel 110 and reports those temperature measurements to the system's control electronics (not shown in FIG. 1).

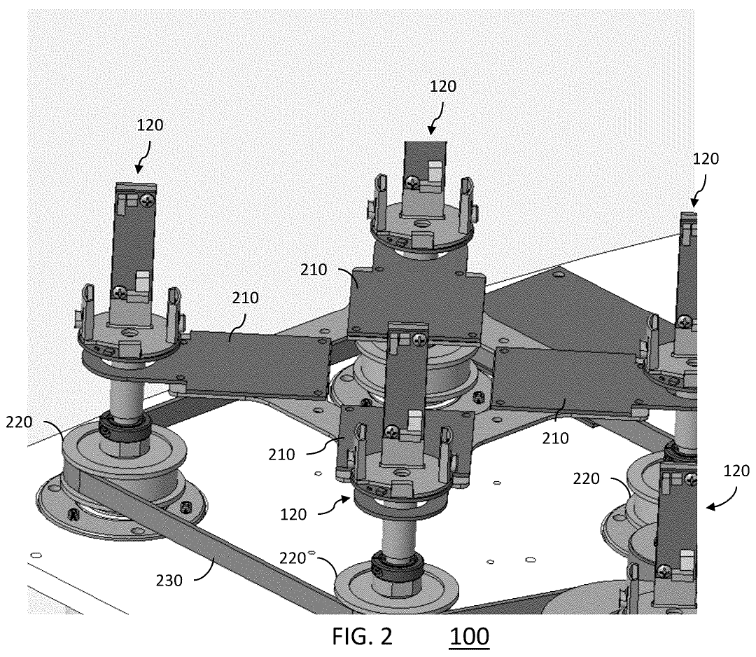

FIG. 2 is a more-detailed, perspective view of one possible implementation of the dissolution testing system 100 of FIG. 1 showing some or all of the top portions of five of the eight shaft assemblies 120. As shown in FIG. 2, each shaft assembly 120 has a pulley wheel 220 driven by a drive belt 230 connected to a motor (not shown) that drives the belt 230 to rotate the shaft assemblies 120 simultaneously in the same direction at the same speed relative to the rest of the (stationary) testing system 100. As shown in FIG. 2, each shaft assembly 120 has its own dedicated reader board 210.

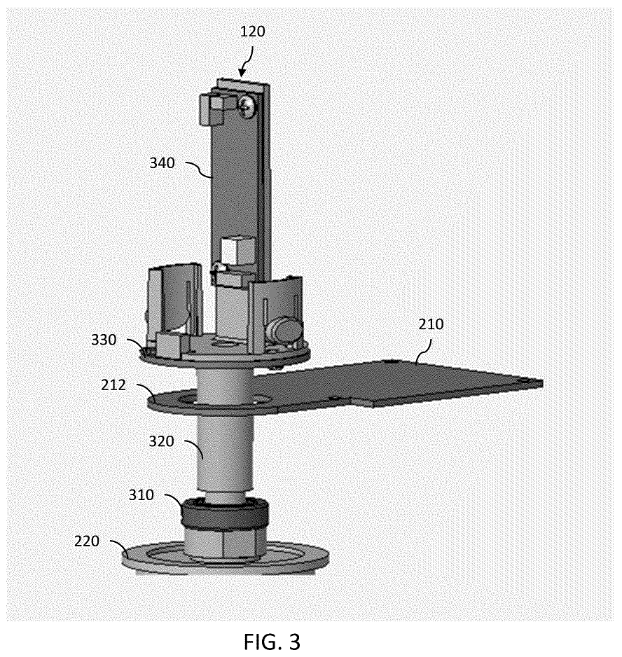

FIG. 3 is a perspective view of the top portion of one of the shaft assemblies 120 of FIG. 2. FIG. 3 shows the shaft collar 310, the shaft-board mount 320, the shaft antenna 330, and the shaft board 340 of the shaft assembly 120. The shaft collar 310 connects the rest of the shaft assembly 120 to the pulley wheel 220. The shaft-board mount 320 supports the shaft antenna 330 and the shaft board 340 on the shaft assembly 120.

Also shown in FIG. 3 is a stationary reader board 210 having a reader antenna 212 that is wirelessly coupled to the nearby shaft antenna 330, where that wireless coupling is maintained as the shaft assembly 120 rotates with respect to the test vessel 110 of FIG. 1 and therefore with respect to the stationary reader board 210.

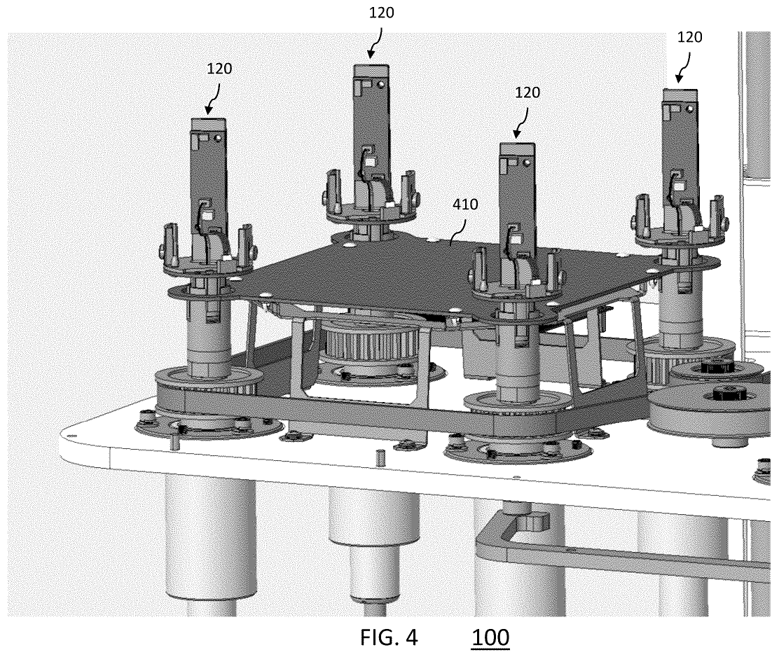

FIG. 4 is a perspective view of another possible implementation of the dissolution testing system 100 of FIG. 1 showing the top portions of four of the eight shaft assemblies 120. Unlike the implementation of FIGS. 2 and 3, in which each shaft assembly 120 has its own separate, dedicated, stationary reader board 210, the implementation of FIG. 4 has a single, combined, stationary reader board 410 for the four shown shaft assemblies 120. In this implementation, the testing system 100 would have a second, combined, stationary reader board for the other four shaft assemblies 120 of the testing system.

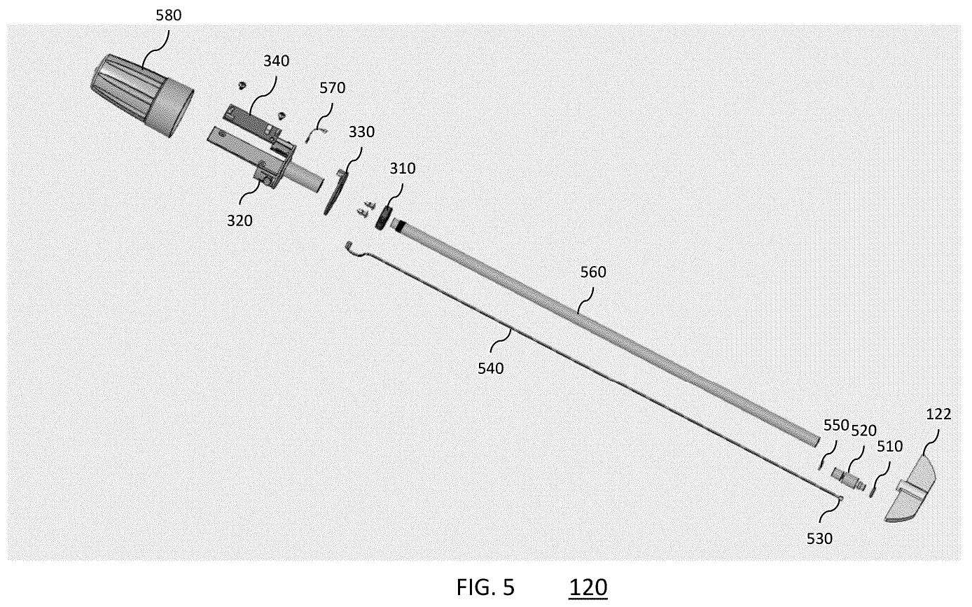

FIG. 5 is an exploded, perspective view of one of the shaft assemblies 120 of FIG. 1. As shown in FIG. 5, the shaft assembly 120 includes a paddle 122, a distal O-ring 510, a temperature-sensor adapter 520, a temperature sensor 530, a two-wire cable 540, a proximal O-ring 550, a hollow shaft 560, a shaft collar 310, a shaft antenna 330, a shaft-board cable 570, a shaft-board mount 320, a shaft board 340, and a protective cap 580.

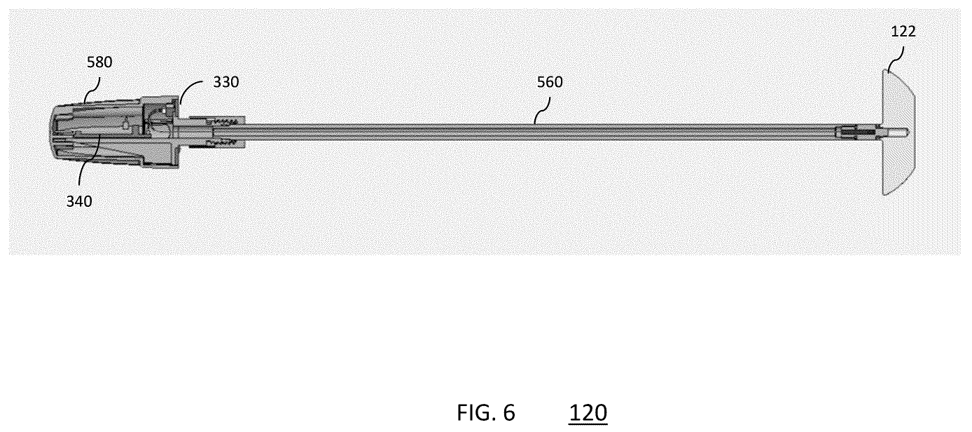

FIG. 6 is a cross-sectional, side view of the shaft assembly 120 of FIG. 5 with the protective cap 580 covering and protecting the shaft board 340.

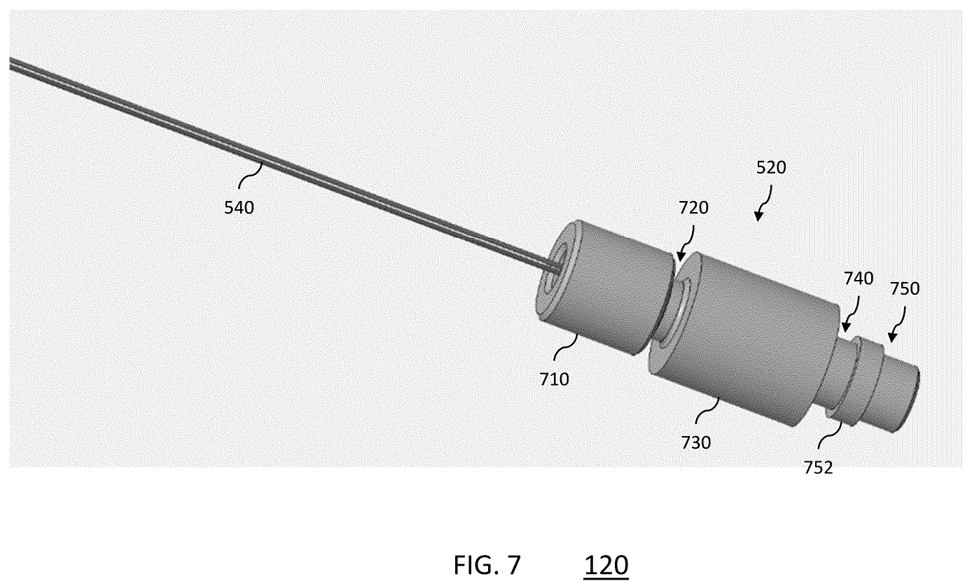

FIG. 7 is a perspective view of the temperature-sensor adapter 520 and the temperature-sensor cable 540 with the temperature sensor 530 (not shown) potted within the adapter 520. As shown in FIG. 7, the adapter 520 has (i) a proximal, O-ring groove 720 separating a threaded, proximal section 710 and a middle section 730 and (ii) a distal, O-ring groove 740 separating the middle section 730 and a distal section 750, where the distal section 750 has a threaded, raised portion 752.

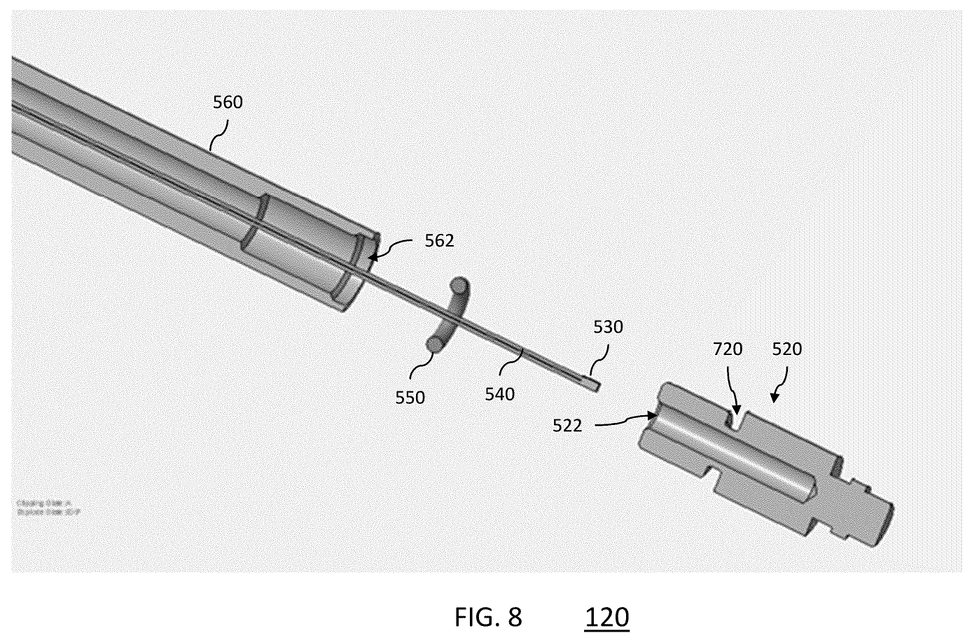

FIG. 8 is a cross-sectional, exploded, perspective view of the adapter 520, the temperature sensor 530 connected at the end of the cable 540, the proximal O-ring 550, and the shaft 560.

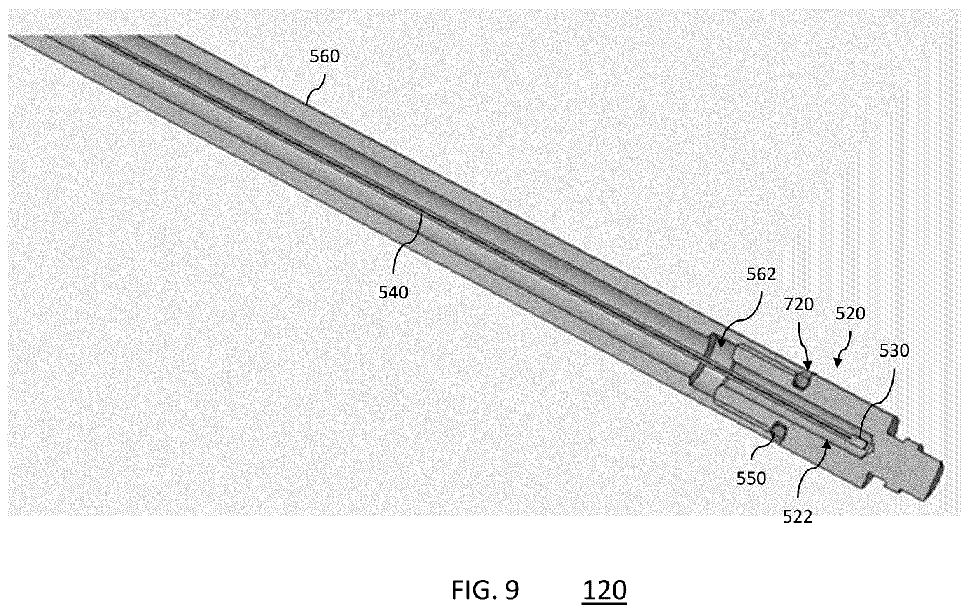

FIG. 9 is a cross-sectional, perspective view of the adapter 520 configured to the open, threaded end 562 of shaft 560 with (i) the proximal O-ring 550 positioned within the proximal, O-ring groove 720 and (ii) the temperature sensor 530 potted within the adapter cavity 522 with the cable 540 extending within the hollow shaft 560.

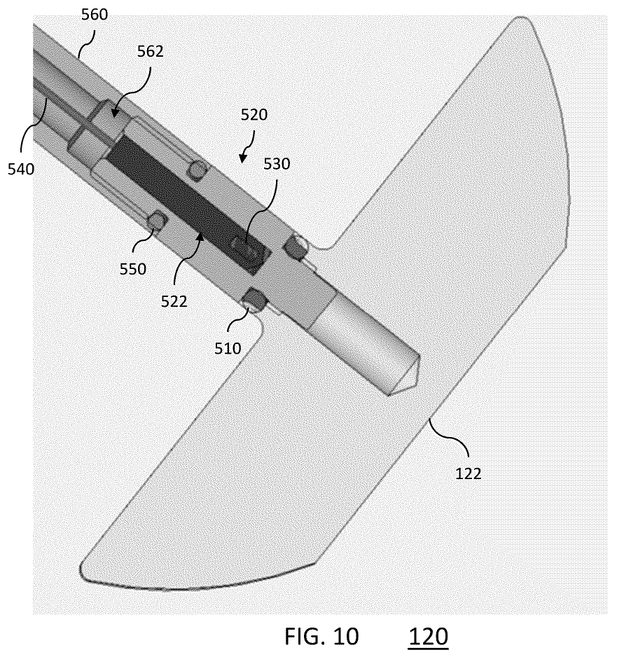

FIG. 10 is a zoomed-in, cross-sectional, side view of the adapter 520 with the temperature sensor 530 connected to the two-wire cable 540 and potted within the adapter cavity 522. As shown in FIG. 10, the threaded, proximal, “male” section 710 of the adapter 520 is screwed into the threaded, distal, “female” end of the shaft 560 with the proximal O-ring 550 residing within the proximal, O-ring groove 720 of the adapter 520 to form a seal between the adapter 520 and the shaft 560 that prevents liquid from seeping into the interior of the hollow shaft 560. Similarly, the threaded, distal, “male” section 752 of the adapter 520 is screwed into the threaded, proximal, “female” end of the paddle 122 with the distal O-ring 510 residing within the distal, O-ring groove 740 of the adapter 520 to form a seal between the adapter 520 and the paddle 122 that prevents liquid from seeping into the interior of the paddle 122.

Referring again to FIG. 5, the cable 540 is electrically connected to the shaft board 340, which is in turn electrically connected to the shaft antenna 330 by the shaft-board cable 570. During dissolution testing, the entire shaft assembly 120, assembled with all of its components shown in the various figures, rotates relative to the stationary test vessel 110 and the stationary reader board 210 of FIGS. 2 and 3 (or, alternatively, the combined reader board 410 of FIG. 4).

In one possible implementation:
The shaft 560 is made of 316 stainless steel;
The adapter 520 is made of stub-machined 316 stainless steel;
The proximal O-ring 550 is a Parker PN-S1138 AS568-009 silicone O-ring from Parker-Hannifin O-Ring Division of Lexington, Kentucky;
The distal O-ring BB is a chemical-resistant, fluoroelastomer, 1/16 fractional width, Viton Dash Number 007 O-ring from The Chemours Company of, Wilmington, Delaware;
The temperature sensor 530 is a 5 mm×2 mm Pt100-385 Alpha Class F0.15 RTD (Resistance Temperature Detector) sensor from Omega Engineering of Swedesboro, New Jersey;
The cable 540 is 2×28AWG, PTFE-jacketed, hookup wire; and
The potting material is Kona 870 FT-LV-DP thermal transfer epoxy from Resin Technology Group LLC of South Easton, Massachusetts.

In certain implementations, the wireless coupling between the reader antenna 212 and the shaft antenna 330 is based on a suitable Near-Field Communication (NFC) protocol that enables (i) electrical energy to flow from the reader antenna 212 to the shaft antenna 330 and (ii) information to flow bidirectionally between the reader antenna 212 and the shaft antenna 330. As understood by those skilled in the art, the electrical energy received by the shaft antenna 330 from the reader antenna 212 is used to power the shaft board 340 as well as the temperature sensor 530 itself.

Furthermore, the information (e.g., based on the ISO 14443 standard) includes both (i) commands and data sent from the reader board 210 to the shaft board 340 and (ii) data sent from the shaft board 340 to the reader board 210. The commands and data sent from the reader board 210 to the shaft board 340 include commands to start analog-to-digital (A/D) conversion, commands to stop A/D conversion, commands to read the NFC tag type, and calibration data to be stored in the EEPROM of the NFC tag. The data sent from the shaft board 340 to the reader board 210 includes temperature information based on temperature measurements generated by the temperature sensor 530, the NFC tag information, and the stored calibration data.

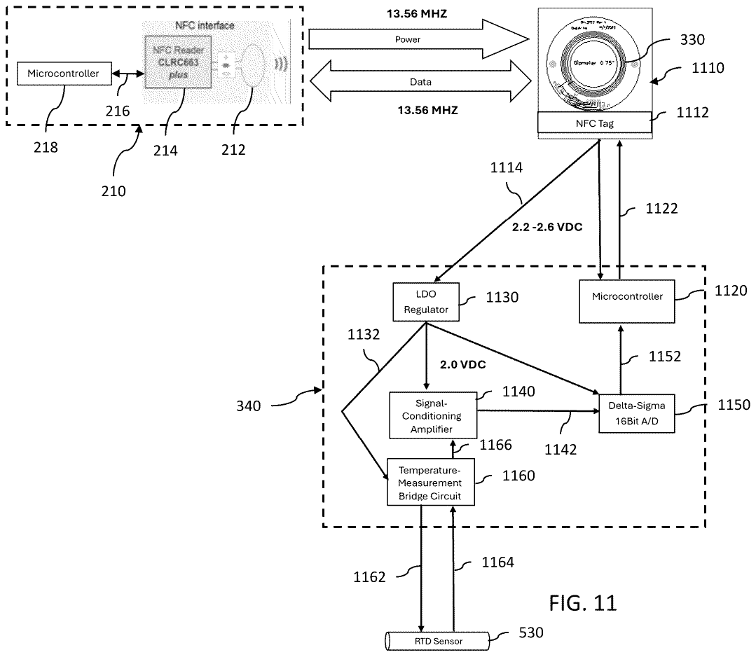

FIG. 11 is a schematic block diagram of the electronics associated with a single shaft assembly 120 of FIG. 1. In particular, FIG. 11 shows the stationary NFC reader board 210 associated with the shaft assembly 120 as well as the electronics of the rotating shaft assembly 120, which includes an NFC unit 1110, a shaft board 340, and an RTD temperature sensor 530. As shown in FIG. 11, the NFC reader board 210 includes a reader antenna 212, an NFC reader chip 214, and an NFC reader microcontroller 218. The NFC unit 1110 includes a shaft antenna 330 and an NFC tag 1112. The shaft board 340 includes a microcontroller 1120, a regulator 1130, a signal-conditioning amplifier 1140, an analog-to-digital (A/D) converter 1150, and a temperature-measurement circuit 1160.

The NFC reader microcontroller 218 can access the NFC tag 1112 (including EEPROM and RAM) over an alternating electro-magnetic field between the reader antenna 212 and the shaft antenna 330. Therefore, the microcontroller 218 of the reader board 210 can communicate with the microcontroller 1120 of the shaft board 340 using the NFC tag 1112.

In operation, under control of the reader microcontroller 218 and the NFC reader chip 214, the reader antenna 212 radiates a wireless, alternating (e.g., 13.56 MHz), magnetic field that is received by the shaft antenna 330. The NFC tag 1112 is a small electronic IC that stores data, harvests electrical energy, and wirelessly transmits and receives data to and from the NFC reader chip 214. The NFC tag 1112 is tuned to resonate with this alternating signal and obtain electrical energy. The resulting, induced AC signal is connected to a diode bridge (built into the NFC tag 1112 and not explicitly shown in FIG. 11) to generate a DC voltage. In one possible implementation, the electrical energy from that received magnetic field is output by the NFC tag 1112 as a variable DC voltage 1114 (e.g., between about 2.2 VDC to about 2.6 VDC, 5 mA) that powers the microcontroller 1120 and is applied to the regulator 1130. The regulator 1130 converts that variable DC voltage 1114 into a stable DC voltage 1132 (e.g., 2.0 VDC, 5 mA) that powers the amplifier 1140, the A/D converter 1150, and the temperature-measurement circuit 1160.

The temperature-measurement circuit 1160 provides, to the temperature sensor 530, a constant (e.g., 1 mA) current 1162 whose analog DC voltage 1164 across the temperature sensor 530 varies as a function of temperature at the temperature sensor 530. In one implementation of the temperature sensor 530 using a two-wire Pt100 RTD sensor, the temperature coefficient of resistance is 0.00385 ohms/ohm/° C. between 0° C. and 100° C. The temperature-measurement circuit 1160 measures the voltage change across the RTD sensor 530 and provides that measured voltage as a corresponding analog, DC voltage signal 1166 to the amplifier 1140, which provides a corresponding, amplified, analog, DC voltage signal 1142 to the A/D converter 1150. The A/D converter 1150 converts the analog, DC voltage signal 1142 into a digital voltage signal 1152 that is transmitted using a suitable serial (e.g., Inter-Integrated Circuit (I²C)) communication protocol to the microcontroller 1120, which, in turn, derives and transmits, to the NFC tag 1112, a corresponding digital temperature signal 1122 using a suitable serial (e.g., I²C) communication protocol.

Based on the digital temperature signal 1122 received from the microcontroller 1120, the NFC tag 1112 controls the RF load connected to the shaft antenna 330, which, in turn, affects the amount of electrical energy received by the shaft antenna 330 from the reader antenna 212 and therefore the amount of electrical energy transmitted by the reader antenna 212. In this way, the NFC tag 1112 modulates the RF energy consumption based on the digital temperature signal 1122. The NFC reader chip 214 detects the changes in the amount of electrical energy transmitted by the reader antenna 212 and demodulates that transmitted electrical energy level to generate a temperature reading 216 corresponding to the temperature at the temperature sensor 530. That temperature reading 216 is transmitted to the reader microcontroller 218, which forwards the temperature reading to the system-level control electronics (not shown) of the dissolution testing system 100 of FIG. 1.

The communication from the NFC tag 1112 to the NFC reader chip 214 is passive. The NFC tag 1112 changes the RF load to encode data, and the NFC reader chip 214 can sense the loading modulation so that the A/D results, the NFC tag type, and the calibration data are sent to the NFC reader chip 214. For each shaft assembly 120, (e.g., voltage-to-temperature) calibration data is saved on an EEPROM (not shown) in the NFC tag 1112.

In general, a dissolution testing system of the present disclosure may have any suitable number of test vessels, each having its own rotating shaft assembly and stationary NFC reader circuitry. Depending on the implementation, the NFC reader circuitry for each shaft assembly may be implemented on its own dedicated NFC reader board, as in NFC reader board 210 of FIG. 11. Alternatively, the NFC reader circuitries for a number of different shaft assemblies may be implemented on a combined NFC reader board, as in reader board 410 of FIG. 4. In either case, the system-level control electronics for the entire dissolution testing system will periodically scan each set of NFC reader circuitry through one or more serial ports to obtain A/D results from all of the shaft assemblies, where calibration data for each shaft is read from the shaft assembly when the testing system is powered on.

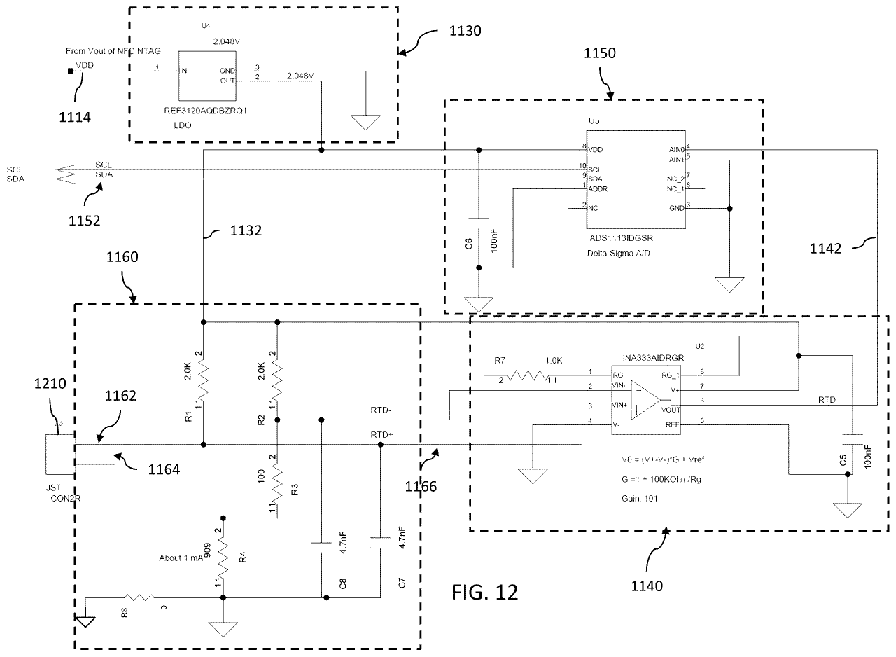

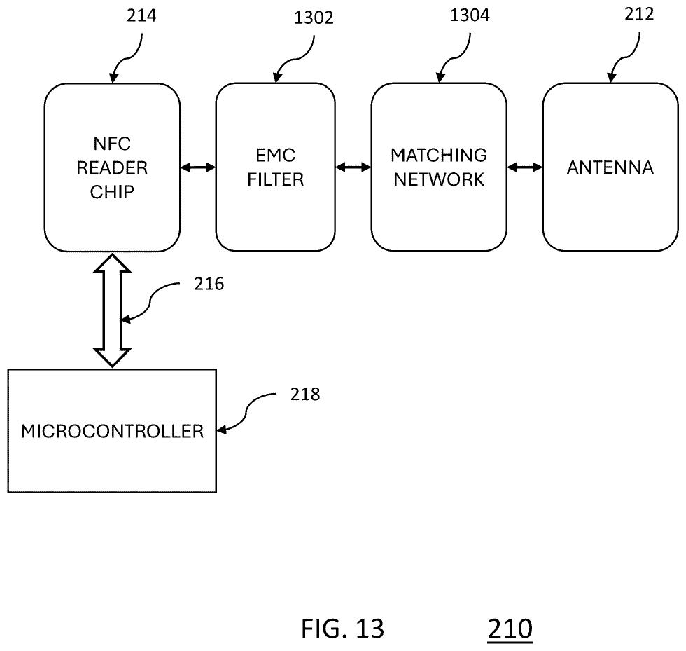

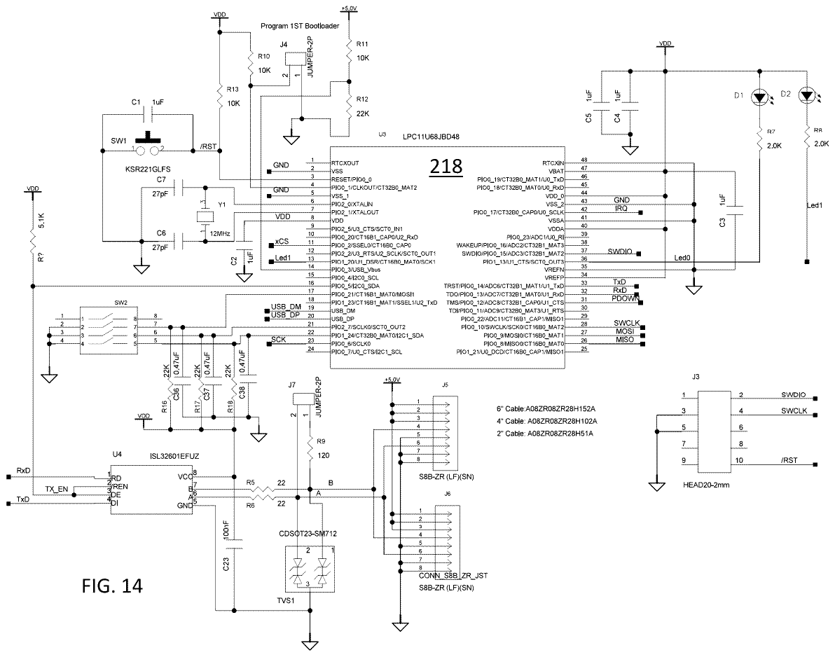

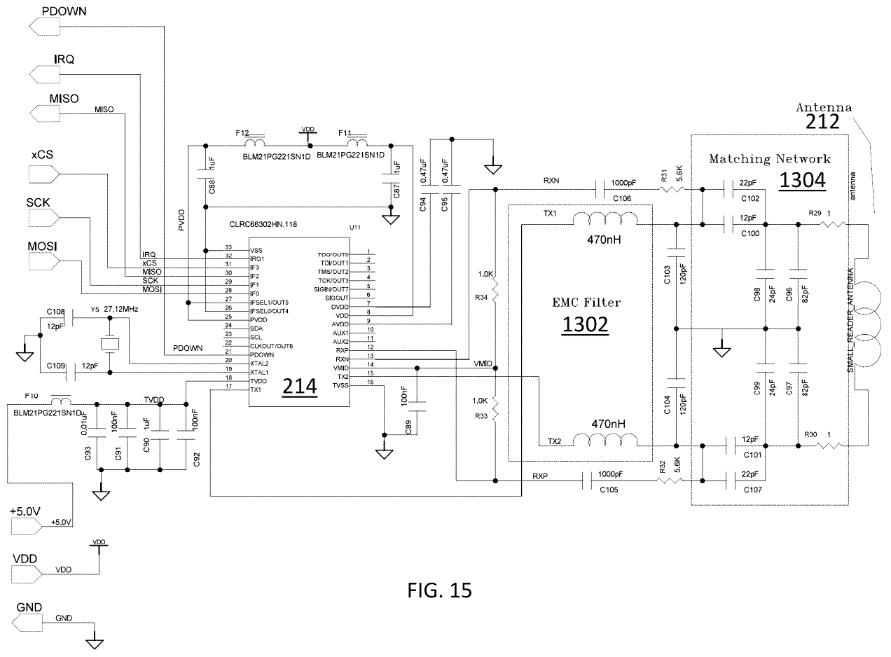

FIG. 12 is a circuit diagram of one possible implementation of the regulator 1130, the signal-conditioning amplifier 1140, the A/D converter 1150, and the temperature-measurement circuit 1160 of FIG. 11, where port 1210 connects to the RTD temperature sensor 530 via the cable 540, VDD is the variable DC voltage from the NFC tag 1112, and the serial clock line SCL and the serial data line SDA form the digital I²C voltage signal 1152 sent to the microcontroller 1120, which calculates the corresponding digital temperature signal 1122 using the formula (Vt×K+P), where Vt is the digital voltage signal 1152 and slope K and intercept P are calibration constants for the RTD sensor 530.

The regulator 1130 is a low drop-out (LDO) regulator. The temperature-measurement circuit 1160 is a resistor-bridge circuit, where the voltage difference across RTD− and RTD+ reflects the resistance of the RTD temperature sensor 530. The resistor-bridge circuit 1160 can measure very small changes in temperature, improve temperature compensation, provide a linear output, and provide high-precision temperature measurements over a wide range. The signal-conditioning amplifier 1140 is a precision, low-power instrument amplifier that amplifies the voltage difference between RTD− and RTD+ with a gain of, for example, about 100. The A/D converter 1150 is a low-power, (e.g., 16-bit) delta-sigma A/D device that uses digital filtering to reduce quantization noise and achieve high resolution.

In one possible implementation of the circuitry of FIGS. 11 and 12:
NFC reader microcontroller 218 is an LPC11U68JBD48 Microcontroller from NXP Semiconductors N.V. of Eindhoven, Netherlands;
NFC reader chip 214 is a CLRC66303HN High-Performance NFC Front-End IC from NXP Semiconductors N.V.;
Reader antenna 212 is a circular, copper, coil trace on a printed circuit board having six turns, a trace width of 250 microns, a trace thickness of 35 microns, a gap between neighboring coil traces of 300 microns, and a diameter of the middle turn of 28 mm;
Shaft antenna 330 is a circular, copper, coil trace on a printed circuit board having five turns, a trace width of 250 microns, a trace thickness of 35 microns, a gap between neighboring coil traces of 300 microns, and a diameter of the middle turn of 23.4 mm;
NFC tag 1112 is an NT3H2211 NTAG I²C Plus NFC Tag from NXP Semiconductors N.V.;
LDO regulator 1130 is an REF3120AQDBZRQ1 LDO regulator from Texas Instruments Incorporated of Dallas, Texas;
Microcontroller 1120 of FIG. 11 is a PIC16LF18326 Low-Power Microcontroller from Extreme Networks, Inc., of San Jose, California;
A/D converter 1150 of FIG. 11 is an ADS1113ID Low-Power 16-Bit A/D Converter from Texas Instruments Incorporated; and
Amplifier 1140 of FIG. 11 is an INA333AIDRG Low-Power Instrumentation Amplifier from Texas Instruments Incorporated.

FIG. 13 is a simplified block diagram of the reader board 210 of FIGS. 2 and 11 for a single shaft assembly 120. One way to implement a reader board for multiple shaft assemblies 120 is simply to integrate on a shared circuit board a different instance of the circuitry of FIG. 13 for each different shaft assembly. In addition to the reader antenna 212, the NFC reader chip 214, and the NFC reader microcontroller 218, the reader board 210 includes an electromagnetic compatibility (EMC) filter 1302 and a matching network 1304.

FIG. 14 is a schematic circuit diagram showing one possible implementation of the circuitry associated with the NFC reader microcontroller 218, and FIG. 15 is a schematic circuit diagram showing one possible implementation of the circuitry associated with the NFC reader chip 214, the EMC filter 1302, the matching network 1304, and the reader antenna 212.

The NFC reader microcontroller 218 initializes and controls the NFC reader chip 214 to send/receive data. The NFC reader microcontroller 218 also turns on/off the NFC reader NFC field. Communications between the NFC reader microcontroller 218 and the NFC reader chip 214 conform to the Serial Peripheral Interface (SPI) standard.

In this implementation, the capacitors and resistors of the EMC filter 1302 are designed to satisfy a cutoff frequency of 21.2 MHz, and the matching network 1304 is designed to match the reader antenna 212 and ensure sufficient power transfer between the reader antenna 212 and the shaft antenna 330.

Commands transmitted from the reader microcontroller 214 to the NFC reader chip 214 may include one or more of the following:
Turn on/off NFC field (i.e., power on/off the NFC tag 1112);
Read data (e.g., A/D results) from the RAM of the NFC tag 1112;
Write data to the RAM of the NFC tag 1112 (e.g., to send data to the microcontroller 1120 of the shaft board 340;
Write data (e.g., calibration data) to the EEPROM of the NFC tag 1112;
Read data (e.g., calibration data) from the EEPROM of the NFC tag 1112;
Set the working mode for the NFC reader chip 214 and the NFC tag 1112;
Read the NFC type of the NFC tag 1112; and
Read the tag ID from the NFC tag 1112.

Although embodiments have been described in which the temperature-sensing assembly is designed and configured to be used in dissolution testing systems, the disclosure is not so limited. In general, in addition to dissolution testing systems, temperature-sensing assemblies of the present disclosure may be employed in any suitable system involving a rotating temperature sensor, such as disintegration testing systems, bioreactors, and any instrument or process equipment requiring temperature measurement in a moving mechanical process.

In certain embodiments, the present disclosure is a testing system (e.g., 100) comprising (i) a stationary reader unit (e.g., 210) comprising a reader antenna (e.g., 212) and reader circuitry (e.g., 214, 218) electrically connected to the reader antenna and (ii) a rotatable shaft assembly (e.g., 120) comprising a temperature sensor (e.g., 530), shaft circuitry (e.g., 340, 1112) electrically connected to the temperature sensor, and a shaft antenna (e.g., 330) electrically connected to the shaft circuitry. The shaft circuitry is adapted to control the shaft antenna based on temperature measurements from the temperature sensor to wirelessly convey corresponding temperature information to the reader circuitry via the reader antenna.

In at least some of the above embodiments, the shaft circuitry comprises a Near-Field Communication (NFC) tag, the reader circuitry comprises an NFC reader chip, and the NFC tag is adapted to convey the temperature information to the NFC reader chip via the shaft antenna and the reader antenna using NFC communications.

In at least some of the above embodiments, the reader unit is adapted to wirelessly transmit, to the shaft assembly via the reader antenna and the shaft antenna, electrical energy for powering the shaft assembly.

In at least some of the above embodiments, the temperature sensor is a resistance temperature detector (RTD) sensor and the shaft circuitry comprises (i) a regulator (e.g., 1130) adapted to generate a stable voltage from a variable voltage recovered from the shaft antenna, (ii) a temperature-measurement circuit (e.g., 1160) adapted to generate a constant current based on the stable voltage from the regulator, apply the constant current to the temperature sensor, and generate an analog voltage (e.g., 1166) based on voltage (e.g., 1164) across the RTD sensor, (iii) a signal-conditioning amplifier (e.g., 1140) powered by the stable voltage from the regulator and adapted to generate an amplified analog voltage (e.g., 1142) based on the analog voltage from the temperature-measurement circuit; (iv) an analog-to-digital (A/D) converter (e.g., 1150) powered by the stable voltage from the regulator and adapted to generate a digital voltage (e.g., 1152) based on the amplified analog voltage from the signal-conditioning amplifier; and (v) a microcontroller (e.g., 1120) powered by the variable voltage recovered from the shaft antenna and adapted to generate a digital temperature signal (e.g., 1122) based on the digital voltage from the A/D converter, wherein the conveyed temperature information is based on the digital temperature signal from the microcontroller.

In at least some of the above embodiments, the testing system comprises a plurality of instances of the rotatable shaft assembly and a different instance of the stationary reader unit for each instance of the rotatable shaft assembly.

In at least some of the above embodiments, each instance of the stationary reader unit is implemented on a separate reader board.

In at least some of the above embodiments, two or more instances of the stationary reader unit are implemented on a single reader board.

In at least some of the above embodiments, the shaft assembly further comprises (i) a shaft (e.g., 560), (ii) an adapter (e.g., 520) connectable to a distal end of the shaft, wherein the temperature sensor is housed within a cavity (e.g., 522) of the adapter, and (iii) a cable (e.g., 540) running through the shaft and electrically connected to the temperature sensor to convey the temperature measurements generated by the temperature sensor to the shaft circuitry.

In at least some of the above embodiments, the adapter is adapted to receive any one of a plurality of different testing attachments.

In at least some of the above embodiments, the cable is further adapted to convey electrical energy to the temperature sensor.

In at least some of the above embodiments, the apparatus is a testing system comprising a test vessel configured to receive a distal end of the shaft assembly such that the temperature sensor is adapted to generate the temperature measurements of a liquid in the test vessel.

In at least some of the above embodiments, the testing system is a dissolution testing system.

In at least some of the above embodiments, the shaft assembly is adapted to rotate with respect to the test vessel.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which electrical energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A testing system (e.g., 100) comprising:
a stationary reader unit (e.g., 210) comprising:
a reader antenna (e.g., 212); and
reader circuitry (e.g., 214, 218) electrically connected to the reader antenna; and
a rotatable shaft assembly (e.g., 120) comprising:
a temperature sensor (e.g., 530);
shaft circuitry (e.g., 340, 1112) electrically connected to the temperature sensor; and
a shaft antenna (e.g., 330) electrically connected to the shaft circuitry, wherein the shaft circuitry is adapted to control the shaft antenna based on temperature measurements from the temperature sensor to wirelessly convey corresponding temperature information to the reader circuitry via the reader antenna.

2. The testing system of claim 1, wherein:
the shaft circuitry comprises a Near-Field Communication (NFC) tag;
the reader circuitry comprises an NFC reader chip; and
the NFC tag is adapted to convey the temperature information to the NFC reader chip via the shaft antenna and the reader antenna using NFC communications.

3. The testing system of claim 1, wherein the reader unit is adapted to wirelessly transmit, to the shaft assembly via the reader antenna and the shaft antenna, electrical energy for powering the shaft assembly.

4. The testing system of claim 3, wherein:
the temperature sensor is a resistance temperature detector (RTD) sensor; and
the shaft circuitry comprises:
a regulator (e.g., 1130) adapted to generate a stable voltage from a variable voltage recovered from the shaft antenna;
a temperature-measurement circuit (e.g., 1160) adapted to generate a constant current based on the stable voltage from the regulator, apply the constant current to the temperature sensor, and generate an analog voltage (e.g., 1166) based on voltage (e.g., 1164) across the RTD sensor;
a signal-conditioning amplifier (e.g., 1140) powered by the stable voltage from the regulator and adapted to generate an amplified analog voltage (e.g., 1142) based on the analog voltage from the temperature-measurement circuit;
an analog-to-digital (A/D) converter (e.g., 1150) powered by the stable voltage from the regulator and adapted to generate a digital voltage (e.g., 1152) based on the amplified analog voltage from the signal-conditioning amplifier; and
a microcontroller (e.g., 1120) powered by the variable voltage recovered from the shaft antenna and adapted to generate a digital temperature signal (e.g., 1122) based on the digital voltage from the A/D converter, wherein the conveyed temperature information is based on the digital temperature signal from the microcontroller.

5. The testing system of claim 1, comprising a plurality of instances of the rotatable shaft assembly and a different instance of the stationary reader unit for each instance of the rotatable shaft assembly.

6. The testing system of claim 5, wherein each instance of the stationary reader unit is implemented on a separate reader board.

7. The testing system of claim 5, wherein two or more instances of the stationary reader unit are implemented on a single reader board.

8. The testing system of claim 1, wherein the shaft assembly further comprises:
a shaft (e.g., 560);
an adapter (e.g., 520) connectable to a distal end of the shaft, wherein the temperature sensor is housed within a cavity (e.g., 522) of the adapter; and
a cable (e.g., 540) running through the shaft and electrically connected to the temperature sensor to convey the temperature measurements generated by the temperature sensor to the shaft circuitry.

9. The apparatus of claim 8, wherein the adapter is adapted to receive any one of a plurality of different testing attachments.

10. The apparatus of claim 8, wherein the cable is further adapted to convey electrical energy to the temperature sensor.

11. The apparatus of claim 1, wherein the apparatus is a testing system comprising a test vessel configured to receive a distal end of the shaft assembly such that the temperature sensor is adapted to generate the temperature measurements of a liquid in the test vessel.

12. The apparatus of claim 11, wherein the testing system is a dissolution testing system.

13. The apparatus of claim 11, wherein the shaft assembly is adapted to rotate with respect to the test vessel.
